(19) United States
(12) Patent Application Publication
(10) Pub. No.: US 2005/0085578 A1
(43) Pub. Date: Apr. 21, 2005

(54) Conductive adhesive and piezo-electric device having piezo-electric element mounted thereon using such adhesive

(76) Inventor: Shuichi Iguchi, Ina-shi (JP)

Correspondence Address: ANDERSON, KILL & OLICK, P.C., 1251 AVENUE OF THE AMERICAS, NEW YORK,, NY, 10020-1182, US

(21) Appl. No.: 10/915,218

(22) Filed: Aug. 9, 2004

(30) Foreign Application Priority Data
Aug. 7, 2003 (JP) 2003-289345

(51) Int. Cl. H02N 2/00

(52) U.S. Cl. 524/403

(57) ABSTRACT

A piezo electric device in which a SAW element 5 is mounted on a base 1 of a package 4 having bonding pads 10,10 connected through bonding wires to corresponding connection terminals 11,11 in the package and having a lid 2 being joined to the base by seam welding and hermetically sealed thereto. The SAW element 5 is bonded and affixed to a mounting surface 6 in the base 1 using a conductive adhesive 7 which contains 80 to 85% resin material by weight and a 20 to 15% flaky conductive filler by weight, or using a conductive adhesive which contains 82.5 to 85% resin material by weight and a 17.5 to 15% conductive filler by weight, wherein the conductive filler comprises a 30% small particulate conductive filler 21 by weight and a 70% large particulate conductive filler 22 by weight.

### FIELD OF THE INVENTION

This invention relates to a conductive adhesive composition and to a piezo-electric device, having, a package with for example, a piezo-electric element such as an SAW (surface acoustic wave) device mounted in the package and bonded to the piezo-electric element using the conductive adhesive composition.

### DESCRIPTION OF THE RELATED ART

SAW devices such as resonators, filters, oscillators and the like utilizing an elastic surface wave SAW element excited by an IDT (interdigital transducer) consisting of interdigital electrodes formed on a surface of a piezo-electric substrate and a reflector are widely used for a variety of electronic apparatus and equipment. Particularly, in recent years, high frequency and high precision SAW devices capable of meeting high-speed requirements of communications are in demand in fields of communications equipment and the like.

Typically, the SAW device utilizes a SAW element mounted in a package having a metallic lid is hermetically joined and sealed by seam welding, via a seal ring, to an upper end of a base formed from a ceramic material. The SAW element has a lower surface bonded and affixed with an adhesive to an empty bottom surface of the base and has an upper surface including bonding pads electrically connected to corresponding connection terminals in the package through a bonding wire. The bonding wire is typically composed of a conductive metal such as aluminum or an aluminum alloy, and has a tip at one end joined to the bonding pad surface using a conventional wedge tool and a bonding method that performs joining by applying ultrasonic vibration and pressure as taught, for example, in Japanese Unexamined Patent Publication No. 2003-110401.

The temperature of the metallic lid may rise to approx. 200—to 500° C. due to the heat generated at the time of seam welding. Hence, the joining operation is carried out in a thermally expanded state higher than the thermal expansion rate of the ceramic base, and yet, when the temperature drops back to the normal temperature after hermetic sealing, the metallic lid contracts more than the base. Consequently, a stress is generated in the base causing the lid to deform it downwardly into a convex geometry. This is conveyed to the SAW element through the adhesive, and may possibly affect its characteristics adversely. Also, this may cause the adhesive to contract when the adhesive is baked and hardened, which may cause additional stress to act on the SAW element. These stresses are not desirable and will affect achieving high frequency and high precision.

A SAW device is proposed in the prior art as taught, for example, in Japanese Unexamined Patent Publication No. 6-177701 and/or Japanese Unexamined Patent Publication No. 2002-16476 having a structure in which an SAW element is bonded and affixed to only the central part of the base of a package or bonded and affixed by an elastic adhesive or through a buffer material. Alternatively a structure is proposed in which a silicon resin layer is formed on a bottom surface of a cavity of a package with a SAW element bonded and affixed thereon using an elastic adhesive which will absorb stress resulting from thermal distortion due to seam welding

To satisfy the high frequency and high precision requirements of SAW devices, an adhesive for bonding and affixing a SAW element requires, the adhesive, subsequent to hardening thereof, to possess a softness property which will enable it to sufficiently absorb thermal deformation during seam welding of the SAW element. The conductive adhesive should possess for example, a low elastic ratio of under 0.1 GPa. At present conventional elastic conductive adhesives which are commercially available consist of an admixture of three kinds of conductive fillers which differ from one another in shape and dimension. A typical example of a conventional conductive adhesive includes a small particle conductive filler with a particle diameter of 2.2-6.2 μm, a large particle conductive filler with a particle diameter of 8.2-14.3 μm, and a small flaky conductive filler having a length of 2.2-4.4 μm in a composition with a silicon type resin material at an appropriate ratio of, for example, 77.5/22.5% by weight. It is believed that such an adhesive composition when coated on a mounting surface of a base and hardened, will cause the three fillers to be unevenly distributed.

More importantly, when a bonding wire tip is pressed to a bonding pad surface using a wedge tool, the conventional adhesive undergoes elastic deformation and causes the SAW element to sink down. The joint state of the bonding wire using the wedge bonding method is determined by such factors as the ultrasonic output, the load on the bonding wire, processing time, and a balance of these. If sinkage of the SAW element is too much, the load on the bonding wire and ultrasonic vibration disappear, thereby making it impossible to form a joint having a proper state.

### SUMMARY OF THE INVENTION

The conductive adhesive of the present invention is capable of fully absorbing stress such as thermal deformation from seam welding the SAW device and realizing wire bonding having the proper state of joint. The conductive adhesive of the present invention permits a piezo-electric device of high quality and high reliability to be fabricated which, in addition to attaining high frequency and high precision, will be able to realize desirable vibration and temperature characteristics, and enhance bondability, that is, ease of joining of the SAW element to the piezo-electric element.

In accordance with a first embodiment of the present invention, the conductive adhesive consists essentially of an 80 to 85% resin material by weight and a 20 to 15% conductive filler by weight, with the conductive filler being composed entirely or almost entirely of conductive particles each of which have a flaky geometry.

It has been discovered that when all or almost all of the conductive fillers are limited to particles having a flaky geometry that upon wire bonding a piezo-electric element to a mounting surface under pressure using the conductive adhesive of the present invention the conductive fillers move mutually in close proximity to one another and will pile up in the conductive adhesive after hardening, so that the resin material existing among the conductive fillers diminishes far less than in a conventional adhesive. As a result, when subjecting the piezo-electric element to wire bonding, under pressure using a wedge tool the conductive adhesive after hardening undergoes less elastic deformation, thereby reducing the sinkage of the piezo-electric element by a large margin and enhancing bondability. Consequently, when connecting the bonding wire a proper state of joint is achieved.

A preferred composition for the flaky conductive filler in the first embodiment is a flaky silver powder, wherein the particles have a length of 4.3 to 6.0 μm.

In accordance with a second embodiment of the present invention, the conductive adhesive consists essentially of a conductive adhesive containing 82.5 to 85% resin material by weight and a 17.5% to 15% conductive filler by weight, with the conductive filler being composed of 30% small particulate conductive filler by weight and 70% large particulate conductive filler by weight. In this embodiment the conductive filler particles may be spherical in geometry.

Using two kinds of large and small particulate conductive fillers causes the particles in the conductive adhesive after hardening to become evenly distributed in a manner such that the small particulate conductive fillers fill the space between adjacent large particulate conductive fillers in an arrangement, one on top of another. In this way less elastic deformation occurs in the resin material so that, when pressurizing by the wedge tool from above in subjecting the piezo-electric element to wire bonding, the conductive adhesive after hardening has less elastic deformation, while maintaining sufficient softness.

In the second embodiment, the small conductive filler may be a silver powder of spherical particles having a diameter of between 2.2 to 6.2 μm, and the large particulate conductive filler may be a particulate silver powder having a spherical geometry and a particle diameter of between 8.2 to 14.3 μm.

Further, according to a separate aspect of this invention, there is provided a piezo-electric device comprising a piezo-electric element and a package to mount the piezo electric element therein, wherein the lower surface of the piezo-electric element is bonded and affixed to the mounting surface of the package using the conductive adhesive of this invention with the upper surface of the piezo-electric element connected by a bonding pad and bonding wire to the connection terminals of the package.

If the piezo-electric element is bonded and affixed by the conductive adhesive of this invention, there is no possibility that the piezo-electric element may sink heavily, even if a heavy load is exerted by a wedge tool on the bonding pad surface of the piezo-electric element when wedge bonding is applied to the bonding wire. Consequently, sufficient ultrasonic vibration and load may be applied to a joint section between the bonding wire and the bonding pad. Especially in regard to the SAW device, there may be obtained sufficient softness and proper joint condition to cope with high frequency and high precision attained thereby.

Also, in a case where there is used a conductive adhesive such that the conductive filler is composed of two kinds of large and small particulate conductive fillers, it is possible to reduce the sinkage of the piezo-electric element, while more sufficient softness may be secured. Accordingly, any impact to the package from the outside by means of stress, a drop and the like due to package deformation, contraction of an adhesive and the like, may be absorbed, and proper motion as well as desired characteristics of the piezo-electric element may be secured, so that a piezo-electric device of high precision and high quality may be obtained.

In another embodiment, of the present invention the package for mounting the piezo-element of a piezo-electric device includes a mounting surface for bonding the piezo-electric element and a lid hermetically joined using the conductive adhesive to the base by seam welding. In this case, even if the base undergoes deformation due to a difference of thermal expansion generating when applying seam welding to the lid, it is possible to eliminate any effect caused by stress on the piezo-electric element.

Preferably, the bonding pad and the bonding wire in the package is composed of aluminum type materials, since they are suitable for wedge bonding.

Moreover, if the piezo-element is an SAW element any possible effect upon the SAW element due to stress from the package and/or external impact may be eliminated. By wire bonding using the conductive adhesive of the present invention the SAW device is capable of attainment of high frequency and high precision.

### BRIEF DESCRIPTION OF THE DRAWINGS

FIG. 1(A) is a plan view showing an embodiment of a SAW device to which this invention is applied, and FIG. 1(B) is a sectional view taken along line I-I of FIG. 1(A);

FIG. 2(A) is a partially enlarged sectional view showing how to carry out wire bonding of a bonding pad of a SAW element;

FIG. 3(A) is a partially enlarged sectional view schematically showing a post-hardening state of a conductive filler in a conductive adhesive of the first embodiment;

FIG. 3(B) is similar to FIG. 3(A) showing the same partially enlarged sectional view in a conductive adhesive of the second embodiment;

FIG. 3(C) is a partially enlarged sectional view showing a post-hardening state of a conductive filler in accordance with the present invention in a conventional conductive adhesive;

FIG. 4 is a schematic diagram showing the results of a heat cycle test of embodiments 1 and 2, and the comparative example at temperatures from −55° C. to 125° C.;

FIG. 5 is a schematic diagram showing the results of a 150 centigrade exposure test of embodiments 1 and 2, and the comparative example.

### DESCRIPTION OF PREFERRED EMBODIMENTS

Referring to attached drawings, a preferred embodiment of a piezo-electric device and a conductive adhesive composition according to this invention will hereafter be described in detail.

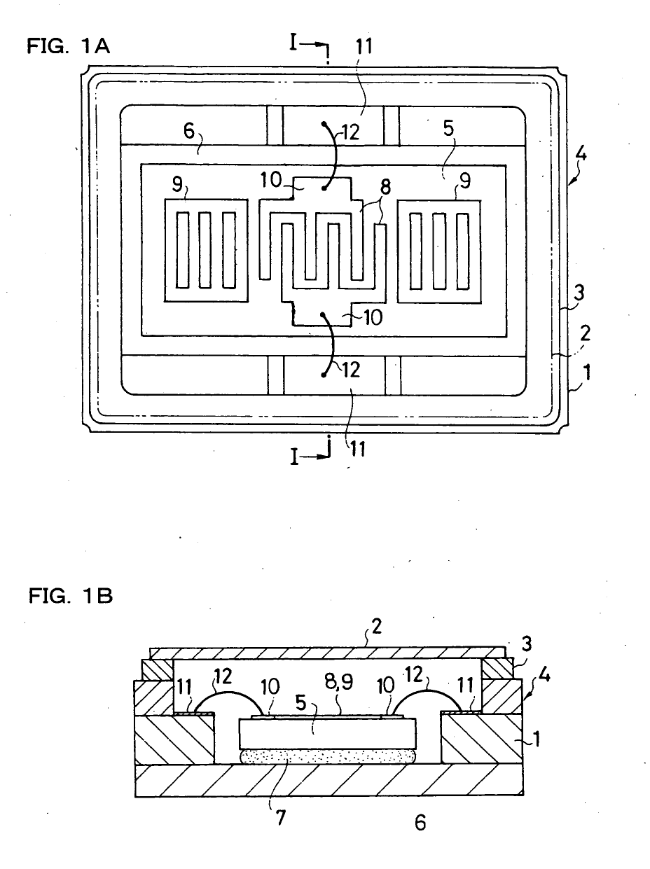

FIG. 1(A) and (B) show an embodiment of an SAW device to which this invention is applied. This SAW device has a package 4 to which a lid 2 of a metallic thin plate hermetically joined by seam welding through a seal ring 3 to an upper end of a rectangular box shape base 1, upper part of which is open, and a SAW element 5 is mounted and sealed therein. The base 1 is composed of multi-layers of a plurality of thin plates consisting of a ceramic material such as alumina. The package 4 has a mounting surface 6 on a bottom part of an empty space as shown demarcated inside the base 1 in the figures. The SAW element 5 is bonded and affixed upon the mounting surface 6 through a conductive adhesive 7.

The SAW element 5 is such that on the center of an upper surface of a rectangular substrate composed of piezo-electric materials such as quartz, lithium tantalate, or lithium niobate, there are formed IDTs consisting of a pair of inter digital transducers 8 and 8, while on both sides in the length direction are formed grid-like reflectors 9 and 9. On each of the inter digital transducers 8 and 8 in continuation with its bus bar, there are formed bonding pads 10 and 10 in proximity to the periphery in the length direction of the substrate. The inter digital transducers, reflectors, and bonding pads of this embodiment are formed of aluminum in consideration of its ease of processing and cost. However, it is possible to use other conductive metallic materials such as aluminum alloys which are typically used.

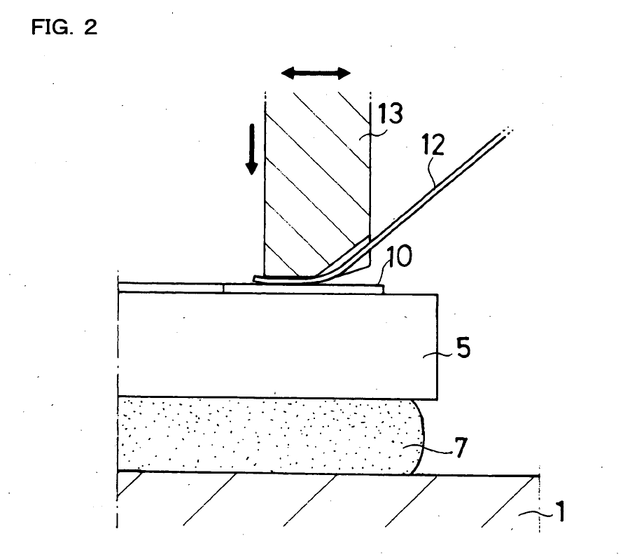

A difference in height exists on both sides of the SAW element 5 in the width direction relative to the height of the base 1 inside the package 4. The base 1 has an upper surface upon which connection terminals 11 and 11 are mounted. The connection terminals 11, 11 are electrically connected to the corresponding bonding pads 10 and 10 on the SAW element 5 through bonding wires 12 and 12 respectively. To prevent a drop of the joint strength due to eutectic, an aluminum wire is used as the bonding wire having the same conductive material as the bonding pad. The connection terminal 11 is formed, for example, by screen printing of metallic wiring materials such as W or Mo to a surface of a ceramic thin plate of the base 1 and plating it with Ni or Au, and then forming on an outer surface of the base 1 a wiring pattern provided on the ceramic thin plate or a via hole (not illustrated) for connection to an external terminal. The bonding wire 12 and the bonding pads 10 and 10 are connected by means of the wedge bonding method using pressure and ultrasonic vibration, after an oxide film is removed from its surface by mechanical cleaning. As shown in FIG. 2, a tip of the bonding wire 12 is pressed at a surface of the bonding pad 10 by a prescribed load, then ultrasonic vibration is added to join the two. After mounting the SAW element 5 and forming a connection in this way, the lid 2 is joined to the seal ring 3 on an upper end of the base 1 by seam welding and the package 4 is hermetically sealed.

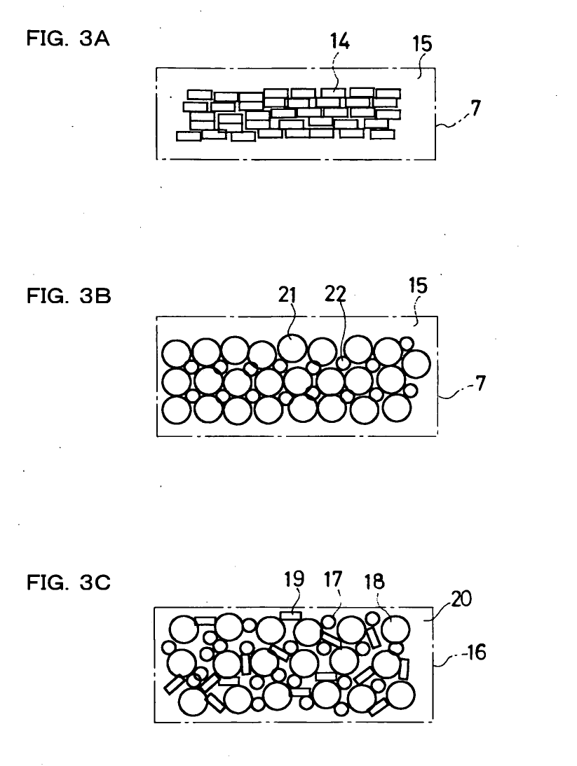

The conductive adhesive 7 according to a first embodiment of this invention contains a conductive filler composed of an 80 to 85% silicon type resin material by weight and a 20 to 15% flaky silver powder by weight. When the lower surface of the SAW element 5 is pressed, bonded, baked, hardened, and affixed onto the conductive adhesive 7 coated on the mounting surface 6 of the base, as shown in FIG. 3(A), the conductive filler 14 is side by side in a manner of piling up in mutual proximities, so that the amount of the resin material 15 existing between the conductive filler particles diminishes. Consequently, when the SAW element 5 is pressed from above by the wedge tool 13 to carry out wire bonding, the conductive adhesive 7 has small plastic deformation and the SAW element 5 is sufficiently supported to reduce the sinkage by a large margin, thus improving bondability and keeping the bonding wire to be connected in a proper joint condition at all times. It is desirable that the conductive filler 14 contained in the conductive adhesive 7 be comprised of nothing but 100% flaky particles or of almost 100% since there is a possibility of some shapes other than the flakes being present in a small percentage. Even in this case, so long as the percentage of flaky particles is virtually close to 100%, sufficient operation/working-effect of this invention may be obtained.

In this embodiment, the conductive filler consists of a flaky silver powder 4.3 to 6.0 μm long, and the conductive adhesive whose hardness after hardening is under 6B and whose elasticity after hardening is under 0.1 Gpa is used.

It is determined that by this means, very good bondability is obtained in wedge bonding of the bonding wire 12, while, at the same time, even if the base 1 deforms due to thermal expansion generated on the lid 2 through high temperature of seam welding and the adhesive 7 contracts upon hardening, its stress may not virtually affect the operation of the SAW element 5. Therefore, it is possible for the SAW device of this invention to attain high frequency and high precision as well as high quality and high reliability.

On the other hand, FIG. 3(C) shows a case where a conventional silicon type conductive adhesive is used for a conductive adhesive 16 which bonds and affixes the SAW element 5. This conventional silicon type conductive adhesive 16 is that which is obtained by adding a conductive filler consisting of, for example, a small particulate conductive filler 17 of a particle diameter of 2.2 to 6.2 μm, a large particulate conductive filler 18 of a particle diameter of 8.2 to 14.3 μm, and a small flaky conductive filler 19, 2.2 to 4.4 μm long to a silicon type resin material 20 at a proper ratio, for example, 22.5/77.5% by weight. Like this embodiment, its hardness after hardening is set under 6B and its elastic rate after hardening is set under 0.1 GPa.

In this manner, three kinds of conductive fillers having different shapes and dimensions are added, and if a content of the resin material increases, three kinds of conductive fillers are distributed unevenly in a layer of the conductive adhesive 16 and many silicon type resin materials exist between the conductive fillers. Consequently, when pressure is applied to the bonding pad surface with the wedge tool, the conductive adhesive 16 undergoes substantial elastic deformation to cause the SAW element to sink heavily, thus making it impossible to obtain proper joint condition.

The conductive adhesive 7 according to a second embodiment of this invention contains an 82.5 to 80% resin material by weight and a 17.5 to 15% conductive filler by weight, the conductive filler comprising a 30% small particulate conductive filler by weight and a 70% large particulate conductive filler by weight. When the lower surface of the SAW element 5 is pressed, bonded, baked, hardened, and affixed onto the conductive adhesive 7 coated on the mounting surface 6 of the base, as shown in FIG. 3(B), in a layer of the conductive adhesive 7, the conductive fillers are piled up one on top of another in a condition in which a small particulate filler 22 is evenly distributed in a manner of filling spaces between an adjacent large particulate conductive filler 21, so that the amount of the resin material 15 existing among the conductive fillers diminishes considerably as compared to the conventional case.

Consequently, when the SAW element 5 is pressed from above by the wedge tool 13 to carry out wire bonding, the conductive adhesive 7 has small plastic deformation and the SAW element 5 is sufficiently supported to reduce the sinkage by a large margin, thus improving bondability and keeping the bonding wire to be connected in a proper joint condition at all times. Furthermore, by comparison to the conductive adhesive of a first embodiment, there is a large gap between the conductive fillers such that it may be possible for more resin material 15 to exist therein, thus enabling sufficient softness to be secured. Consequently, the conductive adhesive 7 is able to absorb any impact from outside such as stress and a drop due to package deformation, adhesive contraction and the like, thus making it possible to secure proper operation and desired characteristics of the SAW element 5. It was found out that especially, if the small conductive filler 21 was a particulate silver powder of a particle diameter of 2.2 to 6.2 μm and if the large conductive filler 22 was a particulate silver powder of a particle diameter of 8.2 to 14.3 μm, it was possible to obtain especially good bondability and softness.

This invention should not be construed as limited to the above-mentioned embodiments. It is apparent to those skilled in the art that various modifications and changes may be made and executed. For example, various publicly known materials other than silver powder may be used for the conductive filler of the conductive adhesive. Further, in regard to various piezo-electric devices having packages mounted with other piezo-electric elements than the SAW element, or tuning fork type or other piezo-electric vibrating reeds, the same may be applicable.

### Embodiment 1

There were respectively manufactured an SAW resonator (this embodiment 1) to which an SAW element is bonded and affixed by using the conductive adhesive of a first embodiment of this invention mentioned above in connection with FIG. 3(A) and an SAW resonator (this embodiment 2) to which an SAW element is bonded and affixed by using the conductive adhesive of a second embodiment of this invention mentioned above in connection with FIG. 3(B). A die attachment condition or pressurizing force when bonding the SAW element to the mounting surface of the base was 20+/−15 g/cm² for both cases, and a hardening condition of the conductive adhesive was set to be N₂ baking for 180° C.×1 hour for this embodiment 1 and vacuum baking for 280° C.×3 hours for this embodiment 2. For the bonding wire, an Al/Si 1% wire of a 40 μm diameter was used, and a commercially available full automatic ultrasonic wedge bonder was used to carry out wedge bonding at conditions of a processing time of 20 ms, an ultrasonic output of 150 W, and a pressurizing force of 50 g. As a comparison example, there was manufactured an SAW resonator having the same structure as this embodiment but using a conventional silicon type conductive adhesive explained in connection with FIG. 3(C).

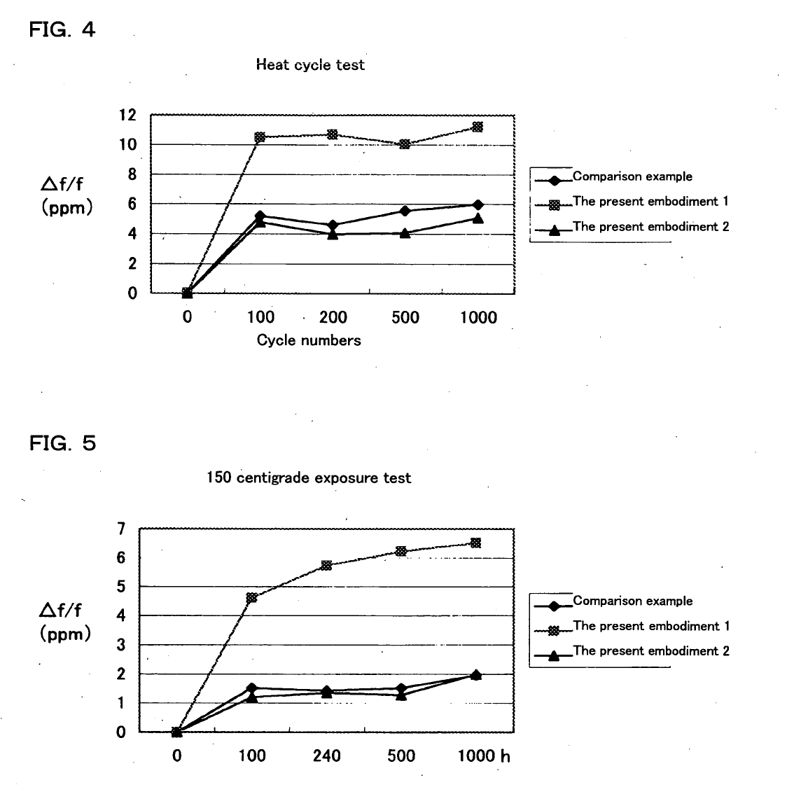

A heat cycle test was conducted on these SAW resonators through repetitions of low temperature and high temperature at −55° C. for 30 minutes and at 125° C. for 30 minutes and a quantity of frequency change Δf/f (ppm) of each SAW resonator was measured to test durability. The results are shown in FIG. 4. The SAW resonator of this embodiment 1 had a larger quantity of frequency change than the comparison example, and, also, its quantity of change was substantially constant even when the repetitions of low temperature and high temperature were conducted 1,000 cycles. The SAW resonator of this embodiment 2 showed substantially the same frequency change as the comparison example.

Next, in regard to these SAW resonators, a test was conducted for letting them stand at 150° C. for 1,000 hours, and a quantity of frequency change Δf/f (ppm) of each SAW resonator with respect to change in time was measured to test durability. The results are shown in FIG. 5. The SAW resonator of this embodiment 1 had a larger quantity of frequency change than the comparison example, and, also, its quantity of change increased little by little with a passage of time. The SAW resonator of this embodiment 2 showed substantially the same frequency change as the comparison example, and both increased slightly when more than 500 hours elapsed.

From these test results, it is inferred that the SAW resonator of this embodiment 1, despite its conductive adhesive being harder than this embodiment 2 and the comparison example, at the same time, showed excellent stability with respect to temperature change. The SAW resonator of this embodiment 2 showed substantially the same temperature characteristics as the comparison example and it was confirmed to possess sufficient softness.

Further, regarding these SAW resonators, the joint condition of the bonding wire was evaluated in terms of its joint strength. For the joint strength, a wire tensile test was employed and a bonding pull strength and breakdown mode were measured. The breakdown mode designates, depending on a breakdown section of a wire, A for interface exfoliation from the package connection terminal, B for cutting in an immediate vicinity of a joint section with the package connection terminal, C for cutting at a wire pull position, D for cutting in an immediate vicinity of a joint section with the SAW element bonding pad, and E for interface exfoliation from the bonding pad. The results are shown in Table 1 below.

TABLE 1

| | | | First Embodiment | | Second Embodiment | |
|---|---|---|---|---|---|---|
| | Comparison Example | | | Break- | | Break- |
| | Pull | Breakdown | Pull | down | Pull | down |
| | strength | mode | strength | mode | strength | mode |
| 1 | 7 | E | 24 | B | 21 | D |
| 2 | 9 | E | 25 | D | 24 | B |
| 3 | 11 | E | 27 | B | 25 | B |
| 4 | 5 | E | 26 | B | 24 | B |
| 5 | 12 | E | 25 | D | 26 | D |
| 6 | 13 | E | 24 | B | 25 | B |
| 7 | 10 | E | 25 | B | 23 | B |
| 8 | 9 | E | 24 | B | 24 | B |
| 9 | 4 | E | 25 | D | 23 | B |
| 10 | 6 | E | 27 | B | 27 | B |
| 11 | 14 | E | 26 | B | 25 | B |
| 12 | 13 | E | 25 | B | 24 | B |
| 13 | 8 | E | 25 | B | 28 | D |
| 14 | 14 | E | 27 | B | 24 | B |
| 15 | 13 | E | 23 | D | 26 | B |
| 16 | 11 | E | 26 | B | 25 | D |
| 17 | 6 | E | 25 | B | 24 | B |
| 18 | 9 | E | 26 | B | 26 | B |
| 19 | 5 | E | 24 | D | 21 | D |
| 20 | 12 | E | 25 | B | 24 | B |
| Aver- | 9.55 | | 25.2 | | 24.45 | |
| age | | | | | | |
| Stand- | 3.24 | | 1.11 | | 1.73 | |
| ard | | | | | | |
| Devi- | | | | | | |
| ation | | | | | | |

In embodiments 1 and 2, a pull strength more than double the comparison example is obtained on an average and breakdown mode is B or D. On the other hand, in the comparison example, the pull strength is not only less than half, but its breakdown mode is all E. From this, it follows that by employing the conductive adhesive of this invention, a sufficient joint strength is obtained for the bonding wire and that joining is properly performed.

1. A conductive adhesive composition consisting essentially of a 80 to 85% resin material by weight and a 20 to 15% conductive filler by weight, wherein: the conductive filler is composed entirely or almost entirely of conductive particles having a flaky nonspherical geometry.

2. The conductive adhesive composition according to claim 1, wherein:
the conductive filler particles consist of a flaky silver powder of 4.3 to 6.0 μm in length.

3. A conductive adhesive composition consisting essentially of an 82.5 to 85% resin material by weight and a 17.5 to 15% conductive filler by weight, wherein the conductive filler comprises a first particulate conductive filler of 30% by weight and a second particulate conductive filler of 70% by weight with the particle size of the second conductive filler being substantially smaller than the particle size of the first conductive filler.

4/ The conductive adhesive composition according to claim 3, wherein:
the first conductive filler is a silver powder of 2.2 to 6.2 μm in particle diameter, and the second conductive filler is a silver powder of 8.2 to 14.3 μm in particle diameter.

5. A piezo-electric device comprising a piezo-electric element, a package having a mounting surface upon which the piezo-electric element is to be mounted and a conductive adhesive for bonding a lower surface of the piezo-electric element to said mounting surface in the package, with said conductive adhesive consisting essentially of an 80 to 85% resin material by weight and a 20 to 15% conductive filler by weight, wherein the conductive filler is composed entirely of conductive particles having a flaky nonspherical geometry.

6. A piezo-electric device comprising a piezo-electric element, a package having a mounting surface upon which the piezo-electric element is to be mounted and a conductive adhesive for bonding a lower surface of the piezo-electric element to said mounting surface in the package, with said conductive adhesive consisting essentially of an 82.5 to 85% resin material by weight and a 17.5 to 15% conductive filler by weight, wherein the conductive filler consists essentially of a first particulate conductive filler of 30% by weight and a second particulate conductive filler of 70% by weight with the particle size of the second conductive filler being substantially smaller than the particle size of the first conductive filler.

7. The piezo-electric device of claim 5 further comprising a bonding pad on an upper surface of the piezo-electric element for connection to a connection terminal of the package by a bonding wire.

8. The piezo-electric device of claim 6 further comprising a bonding pad on an upper surface of the piezo-electric element for connection to a connection terminal of the package by a bonding wire.

9. The piezo-electric device according to claim 7, wherein the package further comprises a base of a ceramic material having the mounting surface and lid hermetically joined to the base by seam welding.

10. The piezo-electric device according to claim 9, wherein:
the bonding pad of the piezo-electric element and the bonding wire are comprised of an aluminum type material.

11. The piezo-electric device according to claim 8, wherein the package further comprises a base of a ceramic material having the mounting surface and lid hermetically joined to the base by seam welding.

12. The piezo-electric device according to claim 11, wherein:
the bonding pad of the piezo-electric element and the bonding wire are comprised of an aluminum type material.

13. The piezo-electric device according to claim 5 wherein:
the piezo-electric element is a surface acoustic wave element.

14. The piezo-electric device according to claim 6 wherein:
the piezo-electric element is a surface acoustic wave element.
